(19) United States
(12) Patent Application Publication
(10) Pub. No.: US 2026/0172294 A1
(43) Pub. Date: Jun. 18, 2026

(54) Method for Controlling Signal Repeater and Non-transitory Computer Readable Storage Medium

(71) Applicants: ANALOGIX (SUZHOU) SEMICONDUCTOR CO., LTD., Suzhou, Jiangsu (CN); ANALOGIX INTERNATIONAL LLC, Wilmington, DE (US)

(72) Inventors: Yizhe LIU, Suzhou, Jiangsu (CN); Liang XUE, Suzhou, Jiangsu (CN); Zhongyuan HOU, Suzhou, Jiangsu (CN)

(21) Appl. No.: 19/126,643

(22) PCT Filed: Jun. 4, 2024
(86) PCT No.: PCT/CN2024/097357

§ 371 Date: May 1, 2025

(30) Foreign Application Priority Data
Aug. 28, 2023 (CN) 202311091444.6

(51) Int. Cl. H04L 25/03

(52) U.S. Cl. CPC H04L 25/03878

(57) ABSTRACT

The present disclosure provides a method for controlling a signal repeater and an apparatus for controlling the signal repeater. The method includes: acquiring an output voltage signal of a comparator and statistical characteristics of the output voltage signal when a linear continuous time equalizer is in each of a plurality of different configuration modes, so as to obtain a plurality of sets of voltage data; acquiring at least one voltage values corresponding to a maximum value of the number in each set of the voltage data, so as to obtain a plurality of target voltage values; determining a voltage data corresponding to a minimum value in the plurality of the target voltage values as target voltage data; and determining the configuration mode corresponding to the target voltage data as a target configuration mode, and setting the linear continuous time equalizer to the target configuration mode.

The present disclosure claims priority to Chinese Patent Application No. 2023110914446, filed to the China National Intellectual Property Administration on Aug. 28, 2023 and entitled “Method for Controlling Signal Repeater and Apparatus for Controlling Signal Repeater” , the disclosure of which is hereby incorporated by reference in its entirety.

### TECHNICAL FIELD

The present disclosure relates to the field of integrated circuits, and in particular, to a method for controlling a signal repeater, a non-transitory computer readable storage medium, and an electronic apparatus.

### BACKGROUND

A signal repeater is a device for enhancing and transmitting a signal, which includes a linear continuous time equalizer for recovering the signal after channel loss. Therefore, the signal repeater has the characteristics of low cost and is widely used in the field of integrated circuits. However, due to different channel conditions, a loss function is also different. If the signal after channel loss is not matched and recovered timely, the recovered signal may not achieve the best effect, and in some cases, the signal quality may even be deteriorated.

Therefore, there is an urgent need for a method to solve the problem that a channel signal of the signal repeater is not recovered and matched timely.

### SUMMARY

The main objective of the present disclosure is to provide a method for controlling a signal repeater, a non-transitory computer readable storage medium, and an electronic apparatus.

According to one aspect of the present disclosure, a method for controlling a signal repeater is provided, the signal repeater includes a linear continuous time equalizer and a comparator which are in communication connection, where the linear continuous time equalizer is configured to recover a loss signal which is received. The method includes: a first acquisition step, an output voltage signal of the comparator and statistical characteristics of the output voltage signal are acquired when the linear continuous time equalizer is in each of a plurality of different configuration modes, and so as to obtain a plurality of sets of voltage data, where one set the voltage data corresponds to one configuration mode, the linear continuous time equalizer has different parameters for recovering the loss signal in any two different configuration modes, and the voltage data includes a plurality of voltage values of the output voltage signal within a predetermined time period and a number corresponding to each of each of the voltage values; a second acquisition step, at least one voltage values corresponding to a maximum value of the number in each set of the voltage data is acquired, and so as to obtain a plurality of target voltage values, where the maximum value of the number in one set the voltage data corresponds to at least one of the voltage values; a first determination step, a voltage data corresponding to a minimum value in the plurality of the target voltage values is determined as target voltage data, where the minimum value in the target voltage values corresponds to at least one set of the voltage data; and a second determination step, the configuration mode corresponding to the target voltage data is determined as a target configuration mode, and the linear continuous time equalizer is set to the target configuration mode.

In some embodiments of the present disclosure, in a case that the maximum value of the number in one set the voltage data corresponds to one voltage value, the second acquisition step includes: one voltage value corresponding to the maximum value of the number in the voltage data is determined as the target voltage value.

In some embodiments of the present disclosure, in a case that the maximum value of the number of one set the voltage data corresponds to a plurality of the voltage values, the second acquisition step includes: the minimum value in the plurality of the voltage values corresponding to the maximum value of the number of the voltage data is determined as the target voltage value.

In some embodiments of the present disclosure, in a case that the minimum value in the target voltage values corresponds to one set of the voltage data, the first determination step includes: one set the voltage data corresponding to the minimum value in the plurality of the target voltage values is determined as the target voltage data.

In some embodiments of the present disclosure, in a case that the minimum value in the target voltage values corresponds to a plurality of sets of the voltage data, the first determination step includes: it is determined

whether a number of sets of the voltage data corresponding to the minimum value in the plurality of the target voltage values is an odd number; in a case that the number of sets of the voltage data corresponding to the minimum value in the plurality of the target voltage values is the odd number, the plurality of sets of the voltage data are sorted according to intensity of the configuration mode corresponding to each set of the voltage data, so as to obtain sequence data, and the voltage data corresponding to a median in the sequence data is determined as the target voltage data, where the intensity of the configuration mode is intensity of the linear continuous time equalizer to recover the loss signal; and in a case that the number of sets of the voltage data corresponding to the minimum value in the plurality of the target voltage values is not the odd number, voltage differences corresponding to the plurality of sets of the voltage data are acquired, so as to obtain the plurality of the voltage differences, and the voltage data corresponding to the maximum value in the plurality of the voltage differences is determined as the target voltage data, where the voltage difference is a difference between a first voltage value and a second voltage value in one set of voltage data, the first voltage value is a voltage value corresponding to the maximum value of the number, and the second voltage value is a voltage value corresponding to the maximum value of the number remaining except the maximum number.

In some embodiments of the present disclosure, the signal repeater further includes a reference signal generator. The reference signal generator is configured to generate a reference signal and input same into the comparator, and before the first acquisition step, the method further includes: a preprocessing step, the resolution of the reference signal is improved.

In some embodiments of the present disclosure, in a case that the minimum value in the target voltage values corresponds to the plurality of sets of the voltage data, the first determination step includes: the voltage differences corresponding to the plurality of sets of the voltage data are acquired, so as to obtain the plurality of the voltage differences, and the voltage data corresponding to the maximum value in the plurality of the voltage differences is determined as the target voltage data, where the voltage difference is the difference between the first voltage value and the second voltage value in one set voltage data, the first voltage value is the voltage value corresponding to the maximum value of the number, and the second voltage value is the voltage value corresponding to the maximum value of a number remaining except the maximum number.

According to still another aspect of the present disclosure, a non-transitory computer readable storage medium is provided, which includes a stored program. The program, when running, controls a device where the computer-readable storage medium is located to perform any one of the above methods.

According to still another aspect of the present disclosure, an electronic apparatus is provided, which includes a memory and a processor. The memory stores a computer program, and the processor is configured to perform any one of the above methods through the computer program.

### BRIEF DESCRIPTION OF THE DRAWINGS

The drawings of the specification, which constitute a part of the present disclosure, are intended to provide a further understanding the present disclosure, and the exemplary embodiments of the present disclosure and the description thereof are used to explain the present disclosure, but do not constitute improper limitations to the present disclosure. In the drawings:

FIG. 1 shows a block diagram of a hardware structure of a mobile terminal for performing a method for controlling a signal repeater according to an embodiment of the present disclosure;

FIG. 2 shows a structure block diagram of a signal repeater according to an embodiment of the present disclosure;

FIG. 3 shows a flowchart of a method for controlling a signal repeater according to an embodiment of the present disclosure;

FIG. 4 shows a structure block diagram of another signal repeater according to an embodiment of the present disclosure;

FIG. 5 shows a schematic diagram of one set of voltage data according to an embodiment of the present disclosure;

FIG. 6 shows a structure block diagram of an apparatus for controlling the signal repeater according to an embodiment of the present disclosure.

Herein, the above drawings include the following reference signs:
102. Processor; 104. Memory; 106. Transmission device; 108. Input/output device; 110. Linear continuous time equalizer; 112. Comparator; 114. Reference signal generator.

### DETAILED DESCRIPTION OF THE EMBODIMENTS

It is to be noted that the embodiments in the present disclosure and features in the embodiments may be combined with each other without conflict. The present disclosure is described below with reference to the drawings and in conjunction with the embodiments in detail.

In order to make the solutions of the present disclosure understood by those skilled in the art, the technical solutions in the embodiments of the present disclosure will be clearly and completely described below in combination with the drawings in the embodiments of the present disclosure. It is apparent that the described embodiments are not all embodiments but only part of embodiments of the present disclosure. All other embodiments obtained by those of ordinary skill in the art on the basis of the embodiments in the present disclosure without creative work shall fall within the scope of protection of the present disclosure.

It is to be noted that terms “first”, “second” and the like in the description, claims and the above drawings of the present disclosure are used for distinguishing similar objects rather than describing a specific sequence or a precedence order. It should be understood that the data used in this way are interchangeable under appropriate circumstances to facilitate the embodiments described herein. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be included instead.

For ease of description, some nouns or terms involved in the embodiments of the present disclosure are explained below:
Signal repeater: a signal repeater is an electronic device for amplifying or enhancing a signal, so as to transmit the signal to a target device far away from a data source, and is mainly used in wireless communication networks, but may also be used in wired communication networks. The signal repeater is a passive network device that does not modify the signal, but only amplifies the signal to enhance the intensity and stability of the signal. The working principle of the signal repeater is that when a data signal is transmitted to the repeater, the repeater amplifies the signal and forwards the signal to the next device. Since the signal is interfered and attenuated during transmission, the repeater may improve the signal quality and transmit the signal to a place farther away from the data source.

As introduced in background, a channel signal of the signal repeater is not recovered and matched timely in the related art. In order to solve the above problem, embodiments of the present disclosure provide a method for controlling a signal repeater, an apparatus for controlling the signal repeater, a non-transitory computer readable storage medium, and an electronic apparatus.

The technical solutions in the embodiments of the present disclosure will be clearly and completely described in conjunction with the drawings in the embodiments of the present disclosure.

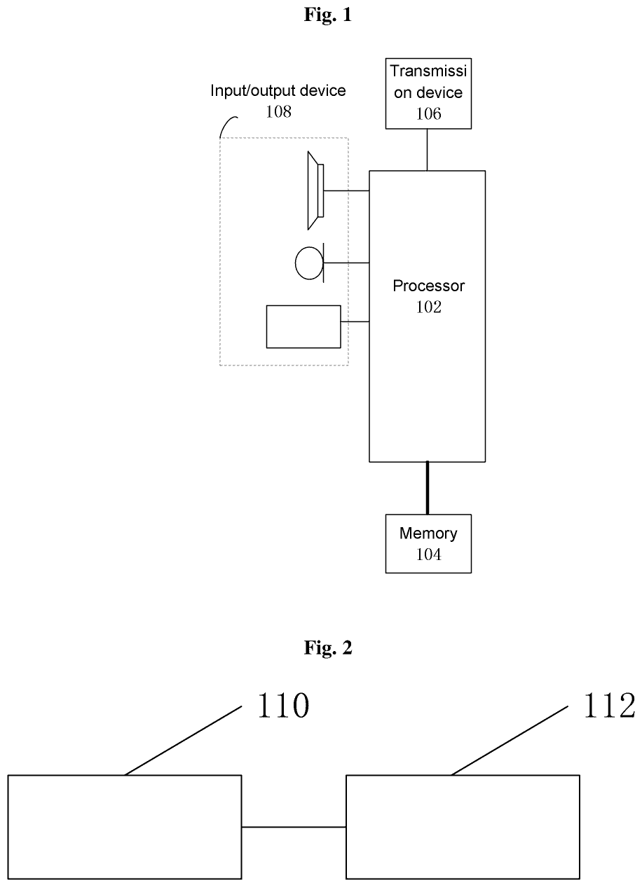

The method embodiment provided by the embodiments of the present disclosure may be implemented in a mobile terminal, a computer terminal or a similar computing apparatus. Taking running on the mobile terminal as an example, FIG. 1 is a block diagram of a hardware structure of a mobile terminal for performing a method for controlling a signal repeater according to an embodiment of the present disclosure. As shown in FIG. 1, the mobile terminal may include one or more (only one is shown in FIG. 1) processors 102 (the processor 102 may include, but is not limited to, a processing apparatus such as a Micro Controller Unit (MCU) or a Field Programmable Gate Array (FPGA) and a memory 104 for storing data. The above mobile terminal may further include a transmission device 106 and an input/output device 108 for communication functions. Those of ordinary skill in the art may understand that the structure shown in FIG. 1 is only schematic and not intended to limit the structure of the above mobile terminal. For example, the mobile terminal may further include more or fewer components than shown in FIG. 1, or has a different configuration from that shown in FIG. 1.

The memory 104 may be configured to store a computer program, for example, a software program and a module of application software, such as a computer program corresponding to a method for controlling a signal repeater in the embodiments of the present disclosure, and the processor 102 performs various functional applications and data processing by running the computer program stored in the memory 104, that is, implements the above method. The memory 104 may include a high speed Random Access Memory (RAM) and may further include a non-volatile memory such as one or more magnetic storage apparatuses, a flash memory, or other non-volatile solid state memories. In some examples, the memory 104 may further include memories remotely located relative to the processor 102, which may be connected to the mobile terminal over a network. The examples of such networks include, but are not limited to, the Internet, the Intranet, local area networks, mobile communication networks, and combinations thereof. The transmission module 106 is configured to receive or send data via a network. A specific example of the network may include a wireless network provided by a communication provider of the mobile terminal. In one example, the transmission device 106 includes a Network Interface Controller (NIC) that may be connected to other network devices through a base station to communicate with the Internet. In one example, the transmission device 106 may be a Radio Frequency (RF) module, for communicating with the Internet wirelessly.

In the embodiment, a method for controlling a signal repeater running on the mobile terminal, the computer terminal or the similar computing apparatus is provided. It is to be noted that the steps shown in the flowchart of the drawings may be executed in a computer system, such as one set of computer-executable instructions, and although a logical sequence is shown in the flowchart, in some cases, the steps shown or described may be executed in a different order than here.

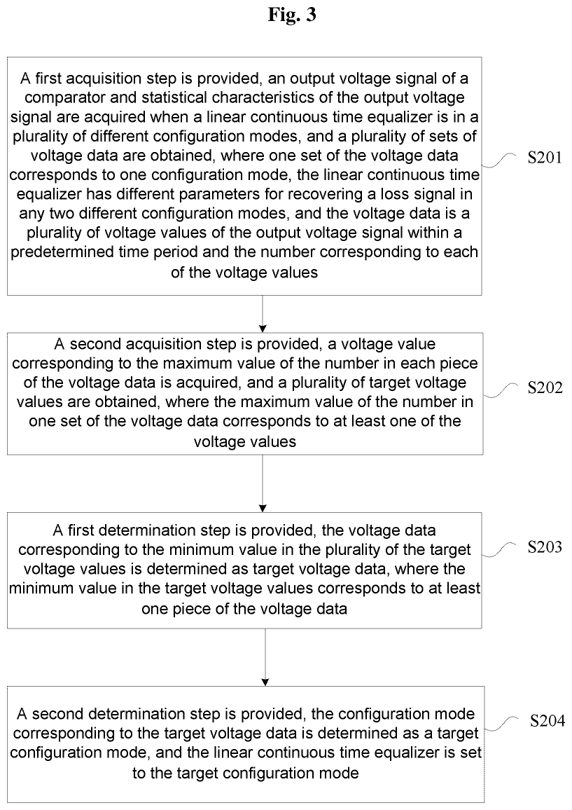

As shown in FIG. 2, the signal repeater of the present disclosure includes a linear continuous time equalizer 110 and a comparator 112 which are in communication connection, where the linear continuous time equalizer 110 is configured to recover a loss signal which is received. FIG. 3 is a flowchart of a method for controlling a signal repeater according to an embodiment of the present disclosure. As shown in FIG. 3, the method includes the following steps:
At S201, a first acquisition step is provided, an output voltage signal of the comparator and statistical characteristics of the output voltage signal are acquired when the linear continuous time equalizer is in each of a plurality of different configuration modes, so as to obtain a plurality of sets of voltage data, where one set the voltage data corresponds to one configuration mode, the linear continuous time equalizer has different parameters for recovering the loss signal in any two different configuration modes, and the voltage data includes a plurality of voltage values of the output voltage signal within a predetermined time period and the number of each of the voltage values;
Specifically, the number and type of the comparators connected to the linear continuous time equalizer are not limited, and the comparator may be one or more. The comparator may be a window comparator, a threshold comparator or a high-speed comparator. The window comparator is configured to compare an input signal according to set upper and lower limit thresholds, and output a high logic level when the input signal is within the range, otherwise output a low logic level. The threshold comparator is the most common type of comparator, which compares the input signal with a preset threshold, and outputs the high logic level or the low logic level when the input signal exceeds or falls below the threshold. The high-speed comparator has a fast response speed and may be configured to high-speed signal processing and data conversion applications. The different configuration modes of the linear continuous time equalizer differ in that the compensation degree for a channel attenuation signal is different, for example, different compensation degrees such as over-compensation, under-compensation, and appropriate compensation, and different degrees of parameter settings are different, so that different corresponding configuration modes are obtained. The statistical characteristics of the output voltage signal may be a statistical distribution or statistical characteristic value of the output voltage signal. The voltage data may be represented in the form of a statistical graph or a statistical table.

At S202, a second acquisition step is provided, at least one voltage values corresponding to the maximum value of the number in each set of the voltage data is acquired, so as to obtain a plurality of target voltage values, where the maximum value of the number in one set the voltage data corresponds to at least one of the voltage values;

Specifically, since in ideal situations, the signal waveform after the loss signal is perfectly recovered is a square waveform, that is, by using the probability statistics theory, the probability mass is distributed at both ends of the voltage signal, that is, the number of the maximum voltage value and the minimum voltage value is the largest. However, in actual situations, the above square waveform may not be achieved, and the maximum value of the number must be a certain distance from the boundary. Therefore, the voltage value corresponding to the maximum value of the number in one set the voltage data may be one or more.

At S203, a first determination step is provided, the voltage data corresponding to the minimum value in the plurality of the target voltage values is determined as target voltage data, where the minimum value in the target voltage values corresponds to at least one set of the voltage data;

Specifically, the voltage value corresponding to the maximum value of the number in one set the voltage data may be one or more, and the target voltage values in the plurality of sets of the voltage data are compared to obtain the voltage data corresponding to the minimum value. Since the distance between the target voltage data and the boundary of the maximum voltage value or the minimum voltage value is smallest, it indicates that the voltage data in this situation is closer to the square wave in the ideal situation.

At S204, a second determination step is provided, the configuration mode corresponding to the target voltage data is determined as a target configuration mode, and the linear continuous time equalizer is set to the target configuration mode.

Specifically, since the distance between the target voltage data and the boundary of the maximum voltage value or the minimum voltage value is smallest, it indicates that the voltage data in this situation is closer to the square wave in the ideal situation, and the configuration mode corresponding to the target voltage data is the most ideal configuration mode under the current condition, and the recovery effect on the loss signal is the best. Applying the technical solution of the present disclosure, a method for controlling a signal repeater is provided. The signal repeater includes the linear continuous time equalizer and the comparator which are in communication connection. First, the output voltage signal of the comparator and the statistical characteristics of the output voltage signal are acquired when the linear continuous time equalizer is in each of the plurality of different configuration modes, and the plurality of sets of the voltage data are obtained. Then, the voltage value corresponding to the maximum value of the number in each set of the voltage data is acquired, and the plurality of the target voltage values are obtained, where the maximum value of the number in one set the voltage data corresponds to at least one of the voltage values. Then, the voltage data corresponding to the minimum value in the plurality of the target voltage values is determined as the target voltage data, where the minimum value in the target voltage values corresponds to at least one set of the voltage data. Finally, the configuration mode corresponding to the target voltage data is determined as the target configuration mode, and the linear continuous time equalizer is set to the target configuration mode. By adding the comparator on the basis of the signal repeater in the related art, performing sampling and statistics on the signal after channel recovery through the comparator, obtaining voltage data results in different configuration modes of the equalizer, and analyzing the voltage data results, a channel state may be quickly acquired, and then the configuration mode of the equalizer is changed, so as to better and quickly adapt to the recovery of the loss signal in different channel states, thereby solving the technical problem that the channel signal of the signal repeater is not recovered and matched timely.

During specific implementation, S202 may be implemented by the following step that: at S2021, in a case that the maximum value of the number in one set the voltage data corresponds to one voltage value, one voltage value corresponding to the maximum value of the number in the voltage data is determined as the target voltage value. According to the method, in a case that the maximum value of the number in one set of the voltage data corresponds to one of the voltage values, the target voltage value may be quickly determined.

Specifically, as shown in FIG. 5, FIG. 5 shows a statistical histogram of one set of voltage data, the horizontal axis of which is the voltage value and the vertical axis is the number corresponding to the voltage value. The maximum value of the number in the figure corresponds to one voltage value 5, that is, 5 may be quickly determined as the target voltage value.

During specific implementation, S202 may also be implemented by the following step that: at S2022, in a case that the maximum value of the number of one set the voltage data corresponds to the plurality of the voltage values, the minimum value in the plurality of the voltage values corresponding to the maximum value of the number of the voltage data is determined as the target voltage value. According to the method, in a case that the maximum value of the number in one set the voltage data corresponds to the plurality of the voltage values, the target voltage value may be quickly determined.

Specifically, in general, in a case that the maximum value of the number in one set the voltage data corresponds to the plurality of the voltage values, the voltage values corresponding to the maximum value are generally two, and the minimum voltage value in the two voltage values is determined to obtain a length value of the voltage value with the maximum number from the boundary.

In order to further quickly determine the target voltage data in a case that the minimum value in the target voltage values corresponds to one set of the voltage data, S203 of the present disclosure may be implemented by the following step: at S2031, in a case that the minimum value in the target voltage values corresponds to one set of the voltage data, one set the voltage data corresponding to the minimum value in the plurality of the target voltage values is determined as the target voltage data.

Specifically, in a case that the minimum target voltage value corresponds to only one set the voltage data, the set of the data may be determined as the target voltage data.

S203 may also be implemented in other manners, for example, at S2032, in a case that the minimum value in the target voltage values corresponds to the plurality of sets of the voltage data, it is determined whether the number of sets of the voltage data corresponding to the minimum value in the plurality of the target voltage values is an odd number; at S2033, in a case that the number of sets of the voltage data corresponding to the minimum value in the plurality of the target voltage values is the odd number, the plurality of sets of the voltage data are sorted according to the intensity of the configuration mode corresponding to each set of the voltage data, so as to obtain sequence data, and the voltage data corresponding to a median in the sequence data is determined as the target voltage data, where the intensity of the configuration mode is the intensity of the linear continuous time equalizer to recover the loss signal; and at S2034, in a case that the number of sets of the voltage data corresponding to the minimum value in the plurality of the target voltage values is not the odd number, voltage differences corresponding to the plurality of sets of the voltage data are acquired, so as to obtain the plurality of the voltage differences, and the voltage data corresponding to the maximum value in the plurality of the voltage differences is determined as the target voltage data, where the voltage difference is a difference between a first voltage value and a second voltage value in one set of voltage data, the first voltage value is a voltage value corresponding to the maximum value of the number, and the second voltage value is a voltage value corresponding to the maximum value of the number remaining except the maximum number. According to the method, in a case that the minimum value in the target voltage values corresponds to the plurality of sets of the voltage data, the target voltage data may be further quickly determined.

Specifically, in a case that the minimum target voltage value corresponds to the plurality of sets of the voltage data, the target voltage data may be quickly determined according to whether the number of sets of the voltage data is an odd number or an even number. In a case that the number of sets of the voltage data corresponding to the minimum target voltage value is the odd number, the plurality of sets of the voltage data are arranged from large to small or from small to large according to the compensation intensity of the corresponding configurations on the loss signal, a set of sequences is obtained, the voltage data located at the median of the set of the sequences is neither under-compensated nor over-compensated compared with the voltage data at both ends, so that the above target voltage data may be determined. In a case that the number of sets of the voltage data corresponding to the minimum target voltage value is the even number, a voltage difference between the maximum number of the voltage values and the second maximum number of the voltage values in each set of the data is directly acquired, and the voltage difference in each set of the data is compared. One set the voltage data with the maximum voltage difference is determined as the target voltage data.

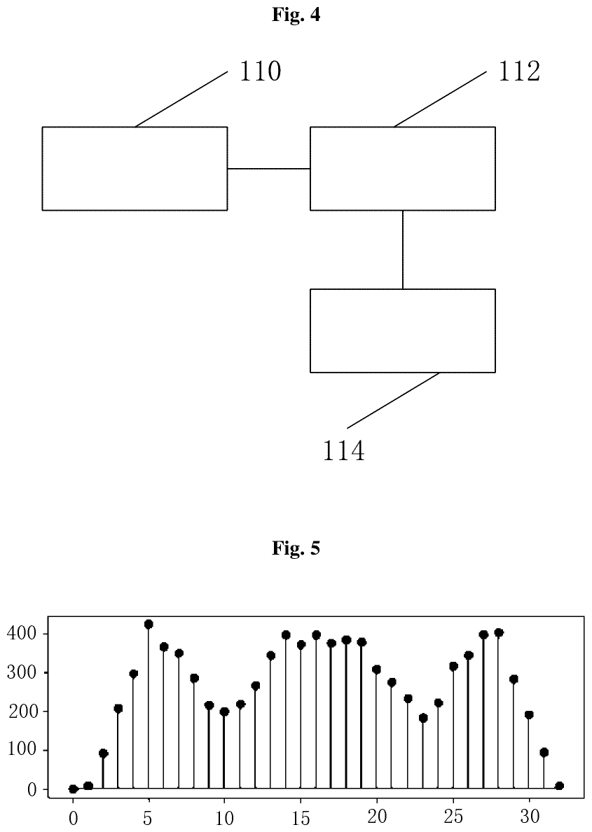

In some embodiments, as shown in FIG. 4, the signal repeater further includes a reference signal generator 114. The reference signal generator 114 is configured to generate a reference signal and input same into the comparator 112, and before S201, the method may be specifically implemented by the following step: a preprocessing step, the resolution of the reference signal is improved. According to the method, the resolution of the voltage data is improved by improving the resolution of the reference signal, which may further achieve the accurate recovery processing of the channel signal of the signal repeater.

Specifically, the reference signal generator may be adjusted to improve the resolution of the generated reference signal output by the reference signal generator, thereby improving the resolution of the voltage data outputted by the comparator. After improving the resolution, the first acquisition step is performed to obtain a plurality of sets of high-resolution voltage data, which further improves the signal recovery accuracy of the signal repeater.

In some embodiments, S203 may also be implemented in other manners, for example, at S2035, in a case that the minimum value in the target voltage values corresponds to the plurality of sets of the voltage data, the voltage differences corresponding to the plurality of sets of the voltage data are acquired, so as to obtain the plurality of the voltage differences, and the voltage data corresponding to the maximum value in the plurality of the voltage differences is determined as the target voltage data, where the voltage difference is the difference between the first voltage value and the second voltage value in one set voltage data, the first voltage value is the voltage value corresponding to the maximum value of the number, and the second voltage value is the voltage value corresponding to the maximum value of the number remaining except the maximum number. According to the method, the signal recovery accuracy of the signal repeater may be further improved.

Specifically, in a case that the minimum value in the target voltage values corresponds to one set of the voltage data, the voltage data is determined as the target voltage data. In a case that the minimum value in the target voltage values corresponds to the plurality of sets of the voltage data, the voltage difference between the maximum number of the voltage values and the second maximum number of the voltage values in each set of the data is directly acquired, and the voltage difference in each set of the data is compared. One set the voltage data with the maximum voltage difference is determined as the target voltage data.

In order to enable those skilled in the art to more clearly understand the technical solutions of the present disclosure, the implementation process of a method for controlling a signal repeater of the present disclosure will be described in detail below in conjunction with specific embodiments.

The embodiment relates to a specific control method for the signal repeater, including the following steps:
At S301: all compensation configurations of the linear continuous time equalizer are scanned, voltage data results under all configurations are obtained, and the voltage value corresponding to the maximum value of the number in each set of the voltage data is obtained;
At S302: the voltage data corresponding to the minimum value in the plurality of the target voltage values is determined;
At S303: in a case that the number of sets of the voltage data corresponding to the minimum value in the plurality of the target voltage values is the odd number, the plurality of sets of the voltage data is sorted according to the intensity of the configuration mode corresponding to each set of the voltage data, the sequence data is obtained, and the voltage data corresponding to the median in the sequence data is determined as the target voltage data;
At S304: in a case that the number of sets of the voltage data corresponding to the minimum value in the plurality of the target voltage values is not the odd number, the voltage differences corresponding to the plurality of sets of the voltage data are acquired, the plurality of the voltage differences are obtained, and the voltage data corresponding to the maximum value in the plurality of the voltage differences is determined as the target voltage data;
At S305: the configuration mode corresponding to the target voltage data is determined as the target configuration mode, and the linear continuous time equalizer is set to the target configuration mode.

The embodiment relates to another specific control method for the signal repeater, including the following steps:
At S401: the reference signal generator is adjusted to refine the resolution of the reference voltage output by the reference signal generator, all compensation configurations of the linear continuous time equalizer are scanned, the voltage data results under all configurations are obtained, and the voltage value corresponding to the maximum value of the number in each set of the voltage data is obtained;
At S402: the voltage data corresponding to the minimum value in the plurality of the target voltage values is determined;
At S403: in a case that the maximum value of the number in one set the voltage data corresponds to one of the voltage values, one of the voltage values corresponding to the maximum value of the number in the voltage data is determined as the target voltage value;
At S404: in a case that the minimum value in the target voltage values corresponds to the plurality of sets of the voltage data, the voltage differences corresponding to the plurality of sets of the voltage data are acquired, the plurality of the voltage differences are obtained, and the voltage data corresponding to the maximum value in the plurality of the voltage differences is determined as the target voltage data.

The embodiments of the present disclosure further provide an apparatus for controlling the signal repeater. It is to be noted that an apparatus for controlling the signal repeater in the embodiments of the present disclosure may be configured to perform a method for controlling a signal repeater provided by the embodiments of the present disclosure. The apparatus is configured to implement the above embodiments and preferred implementations. The embodiments and preferred implementations that have been elaborated will not be repeated here. The term “module” used below can realize a combination of software and/or hardware with an intended function. Although the device described in the following embodiment is preferably realized by software, but by hardware or a combination of software and hardware is also possible and conceived.

An apparatus for controlling the signal repeater provided by the embodiments of the present disclosure will be described below.

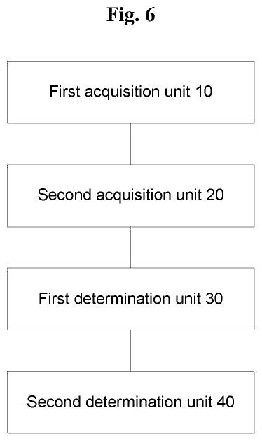

As shown in FIG. 2, the signal repeater of the present disclosure includes a linear continuous time equalizer 110 and a comparator 112 which are in communication connection, where the linear continuous time equalizer 110 is configured to recover a loss signal which is received. FIG. 6 is a schematic diagram of an apparatus for controlling the signal repeater according to an embodiment of the present disclosure. As shown in FIG. 6, the apparatus includes:
The first acquisition unit 10, configured to perform a first acquisition step of acquiring an output voltage signal of the comparator and statistical characteristics of the output voltage signal when the linear continuous time equalizer is in each of a plurality of different configuration modes, so as to obtain a plurality of sets of voltage data, where one set the voltage data corresponds to one configuration mode, the linear continuous time

equalizer has different parameters for recovering the loss signal in any two different configuration modes, and the voltage data includes a plurality of voltage values of the output voltage signal within a predetermined time period and the number of each of the voltage values;

Specifically, the number and type of comparators connected to the linear continuous time equalizer are not limited, and the comparator may be one or more. The comparator may be a window comparator, a threshold comparator or a high-speed comparator. The window comparator is configured to compare an input signal according to set upper and lower limit thresholds, and output a high logic level when the input signal is within the range, otherwise output a low logic level. The threshold comparator is the most common type of comparator, which compares the input signal with a preset threshold, and outputs the high logic level or the low logic level when the input signal exceeds or falls below the threshold. The high-speed comparator has a fast response speed and may be configured to high-speed signal processing and data conversion applications. The different configuration modes of the linear continuous time equalizer differ in that the compensation degree for a channel attenuation signal is different, for example, different compensation degrees such as over-compensation, under-compensation, and appropriate compensation, and different degrees of parameter settings are different, so that different corresponding configuration modes are obtained. The statistical characteristics of the output voltage signal may be a statistical distribution or statistical characteristic value of the output voltage signal. The voltage data may be represented in the form of a statistical graph or a statistical table.

The second acquisition unit 20, configured to perform a second acquisition step of acquiring at least one voltage value corresponding to the maximum value of the number in each set of the voltage data, so as to obtain a plurality of target voltage values, where the maximum value of the number in one set the voltage data corresponds to at least one of the voltage values;

Specifically, since in ideal situations, the signal waveform after the loss signal is perfectly recovered is a square waveform, that is, using the probability statistics theory, the probability mass is distributed at both ends of the voltage signal, that is, the number of the maximum voltage value and the minimum voltage value is the largest. However, in the actual situation, the above square waveform may not be achieved, and the maximum value of the number must be a certain distance from the boundary. Therefore, the voltage value corresponding to the maximum value of the number in one set the voltage data may be one or more.

The first determination unit 30, configured to perform a first determination step of determining the voltage data corresponding to the minimum value in the plurality of the target voltage values as target voltage data, where the minimum value in the target voltage values corresponds to at least one set of the voltage data;

Specifically, the voltage value corresponding to the maximum value of the number in one set the voltage data may be one or more, and the target voltage values in the plurality of sets of the voltage data are compared to obtain the voltage data corresponding to the minimum value. Since the distance between the target voltage data and the boundary of the maximum voltage value or the minimum voltage value is smallest, it indicates that the voltage data in this situation is closer to the square wave in the ideal situation.

The second determination unit 40, configured to perform a second determination step of determining the configuration mode corresponding to the target voltage data as a target configuration mode, and setting the linear continuous time equalizer to the target configuration mode.

Specifically, since the distance between the target voltage data and the boundary of the maximum voltage value or the minimum voltage value is smallest, it indicates that the voltage data in this situation is closer to the square wave in the ideal situation, and the configuration mode corresponding to the target voltage data is the most ideal configuration mode under the current condition, and the recovery effect on the loss signal is the best.

In some embodiments, an apparatus for controlling the signal repeater is provided. The signal repeater includes the linear continuous time equalizer and the comparator which are in communication connection, where the linear continuous time equalizer is configured to recover the loss signal which is received. The apparatus includes: the first acquisition unit, configured to acquire the output voltage signal of the comparator and the statistical characteristics of the output voltage signal when the linear continuous time equalizer is in each of the plurality of different configuration modes, and obtain the plurality of sets of the voltage data; the second acquisition unit, configured to acquire the voltage value corresponding to the maximum value of the number in each set of the voltage data, and obtain the plurality of the target voltage values, where the maximum value of the number in one set the voltage data corresponds to at least one of the voltage values; the first determination unit, configured to determine the voltage data corresponding to the minimum value in the plurality of the target voltage values as the target voltage data, where the minimum value in the target voltage values corresponds to at least one set of the voltage data; and the second determination unit, configured to determine the configuration mode corresponding to the target voltage data as the target configuration mode, and set the linear continuous time equalizer to the target configuration mode. By adding the comparator on the basis of the signal repeater in the related art, performing sampling and statistics on the signal after channel recovery through the comparator, obtaining voltage data results in different configuration modes of the equalizer, and analyzing the voltage data results, a channel state may be quickly acquired, and then the configuration mode of the equalizer is changed, so as to better and quickly adapt to the recovery of the loss signal in different channel states, thereby solving the technical problem that the channel signal of the signal repeater is not recovered and matched timely.

In some embodiment, the second acquisition unit is further configured to determine, in a case that the maximum value of the number in one set the voltage data corresponds to one of the voltage values, one voltage value corresponding to the maximum value of the number in the voltage data as the target voltage value. According to the apparatus, in a case that the maximum value of the number in one set the voltage data corresponds to one of the voltage values, the target voltage value may be quickly determined.

Specifically, as shown in FIG. 5, FIG. 5 shows a statistical histogram of one set voltage data, the horizontal axis of which is the voltage value and the vertical axis is the number corresponding to the voltage value. The maximum value of the number in the figure corresponds to one voltage value 5, that is, 5 may be quickly determined as the target voltage value.

In some embodiment, the second acquisition unit is further configured to determine, in a case that the maximum value of the number of one set the voltage data corresponds to the plurality of the voltage values, the minimum value in the plurality of the voltage values corresponding to the maximum value of the number of the voltage data as the target voltage value. According to the apparatus, in a case that the maximum value of the number of one set the voltage data corresponds to the plurality of the voltage values, the target voltage value may be quickly determined.

Specifically, in general, in a case that the maximum value of the number in one set the voltage data corresponds to the plurality of the voltage values, the voltage values corresponding to the maximum value are generally two, and the minimum voltage value in the two voltage values is determined to obtain a length value of the voltage value with the maximum number from the boundary.

In order to further quickly determine the target voltage data in a case that the minimum value in the target voltage values corresponds to one set of the voltage data, the first determination unit of the present disclosure includes a first determination module, configured to determine, in a case that the minimum value in the target voltage values corresponds to one set of the voltage data, one set the voltage data corresponding to the minimum value in the plurality of the target voltage values as the target voltage data.

Specifically, in a case that the minimum target voltage value corresponds to only one set the voltage data, the set of the data may be determined as the target voltage data.

In some embodiments, the first determination unit further includes a second determination module, a third determination module, and a fourth determination module. The second determination module is configured to determine, in a case that the minimum value in the target voltage values corresponds to the plurality of sets of the voltage data, whether the number of sets of the voltage data corresponding to the minimum value in the plurality of the target voltage values is an odd number. The third determination module is configured to sort, in a case that the number of sets of the voltage data corresponding to the minimum value in the plurality of the target voltage values is the odd number, the plurality of sets of the voltage data according to the intensity of the configuration mode corresponding to each set of the voltage data, so as to obtain sequence data, and determine the voltage data corresponding to a median in the sequence data as the target voltage data, where the intensity of the configuration mode is the intensity of the linear continuous time equalizer to recover the loss signal. The fourth determination module is configured to acquire, in a case that the number of sets of the voltage data corresponding to the minimum value in the plurality of the target voltage values is not the odd number, voltage differences corresponding to the plurality of sets of the voltage data, so as to obtain the plurality of the voltage differences, and determine the voltage data corresponding to the maximum value in the plurality of the voltage differences as the target voltage data, where the voltage difference is a difference between a first voltage value and a second voltage value in one set of voltage data, the first voltage value is a voltage value corresponding to the maximum value of the number, and the second voltage value is a voltage value corresponding to the maximum value of the number remaining except the maximum number. According to the apparatus, in a case that the minimum value in the target voltage values corresponds to the plurality of sets of the voltage data, the target voltage data may be further quickly determined.

Specifically, in a case that the minimum target voltage value corresponds to the plurality of sets of the voltage data, the target voltage data may be quickly determined according to whether the number of sets of the voltage data is an odd number or an even number. In a case that the number of sets of the voltage data corresponding to the minimum target voltage value is the odd number, the plurality of sets of the voltage data are arranged from large to small or from small to large according to the compensation intensity of the corresponding configurations on the loss signal, a set of sequences is obtained, the voltage data located at the median of the set of the sequences is neither under-compensated nor over-compensated compared with the voltage data at both ends, so that the above target voltage data may be determined. In a case that the number of sets of the voltage data corresponding to the minimum target voltage value is the even number, a voltage difference between the maximum number of the voltage values and the second maximum number of the voltage values in each set of the data is directly acquired, and the voltage difference in each set of the data is compared. One set the voltage data with the maximum voltage difference is determined as the target voltage data.

In some embodiments, as shown in FIG. 4, the signal repeater further includes a reference signal generator 114. The reference signal generator 114 is configured to generate a reference signal and input same into the comparator 112, and the apparatus further includes a processing unit, configured to improve the resolution of the reference signal. According to the apparatus, the resolution of the voltage data is improved by improving the resolution of the reference signal, which may further achieve the accurate recovery processing of the channel signal of the signal repeater.

Specifically, the reference signal generator may be adjusted to improve the resolution of the generated reference signal output by the reference signal generator, thereby improving the resolution of the voltage data outputted by the comparator. After improving the resolution, the first acquisition step is performed to obtain a plurality of sets of high-resolution voltage data, which further improves the signal recovery accuracy of the signal repeater.

In some embodiments, the first determination unit further includes a fifth determination module, configured to acquire, in a case that the minimum value in the target voltage values corresponds to the plurality of sets of the voltage data, the voltage differences corresponding to the plurality of sets of the voltage data, so as to obtain the plurality of the voltage differences, and determine the voltage data corresponding to the maximum value in the plurality of the voltage differences as the target voltage data, where the voltage difference is the difference between the first voltage value and the second voltage value in one set voltage data, the first voltage value is the voltage value corresponding to the maximum value of the number, and the second voltage value is the voltage value corresponding to the maximum value of the number remaining except the maximum number. According to the apparatus, the signal recovery accuracy of the signal repeater may be further improved.

Specifically, in a case that the minimum value in the target voltage values corresponds to one set of the voltage data, the voltage data is determined as the target voltage data. In a case that the minimum value in the target voltage values corresponds to the plurality of sets of the voltage data, the voltage difference between the maximum number of the voltage values and the second maximum number of the voltage values in each set of the data is directly acquired, and the voltage difference in each set of the data is compared. One set the voltage data with the maximum voltage difference is determined as the target voltage data.

An apparatus for controlling the signal repeater includes a processor and a memory. The first acquisition unit, the second acquisition unit, the first determination unit, and the second determination unit are all stored in the memory as program units, and the processor executes the above program units stored in the memory to implement the corresponding functions. The above modules are in the same processor; or, the above modules are respectively in different processors in form of any combination.

The processor includes a kernel, and the kernel calls the corresponding program unit from the memory. One or more kernels may be provided, and the signal repeater is controlled by adjusting kernel parameters.

The memory may include a volatile memory, an RAM and/or a non-volatile memory in a computer-readable medium, such as an Read-Only Memory (ROM) or a flash memory (flash RAM), and the memory includes at least one memory chip.

The embodiments of the present disclosure provide a non-transitory computer readable storage medium, which includes a stored program. The program, when running, controls a device where the computer-readable storage medium is located to perform a method for controlling a signal repeater.

Specifically, a method for controlling a signal repeater includes the following operations:
At S201, a first acquisition step is provided, an output voltage signal of the comparator and statistical characteristics of the output voltage signal are acquired when the linear continuous time equalizer is in each of a plurality of different configuration modes, so as to obtain a plurality of sets of voltage data, where one set the voltage data corresponds to one configuration mode, the linear continuous time equalizer has different parameters for recovering the loss signal in any two different configuration modes, and the voltage data includes a plurality of voltage values of the output voltage signal within a predetermined time period and the number of each of the voltage values;

Specifically, the number and type of comparators connected to the linear continuous time equalizer are not limited, and the comparator may be one or more. The comparator may be a window comparator, a threshold comparator or a high-speed comparator. The window comparator is configured to compare an input signal according to set upper and lower limit thresholds, and output a high logic level when the input signal is within the range, otherwise output a low logic level. The threshold comparator is the most common type of comparator, which compares the input signal with a preset threshold, and outputs the high logic level or the low logic level when the input signal exceeds or falls below the threshold. The high-speed comparator has a fast response speed and may be configured to high-speed signal processing and data conversion applications. The different configuration modes of the linear continuous time equalizer differ in that the compensation degree for a channel attenuation signal is different, for example, different compensation degrees such as over-compensation, under-compensation, and appropriate compensation, and different degrees of parameter settings are different, so that different corresponding configuration modes are obtained. The statistical characteristics of the output voltage signal may be a statistical distribution or statistical characteristic value of the output voltage signal. The voltage data may be represented in the form of a statistical graph or a statistical table.

At S202, a second acquisition step is provided, at least one voltage values corresponding to the maximum value of the number in each set of the voltage data is acquired, so as to obtain a plurality of target voltage values, where the maximum value of the number in one set the voltage data corresponds to at least one of the voltage values;

Specifically, since in ideal situations, the signal waveform after the loss signal is perfectly recovered is a square waveform, that is, using the probability statistics theory, the probability mass is distributed at both ends of the voltage signal, that is, the number of the maximum voltage value and the minimum voltage value is the largest. However, in actual situations, the above square waveform may not be achieved, and the maximum value of the number must be a certain distance from the boundary. Therefore, the voltage value corresponding to the maximum value of the number in one set the voltage data may be one or more.

At S203, a first determination step is provided, the voltage data corresponding to the minimum value in the plurality of the target voltage values is determined as target voltage data, where the minimum value in the target voltage values corresponds to at least one set of the voltage data;

Specifically, the voltage value corresponding to the maximum value of the number in one set the voltage data may be one or more, and the target voltage values in the plurality of sets of the voltage data are compared to obtain the voltage data corresponding to the minimum value. Since the distance between the target voltage data and the boundary of the maximum voltage value or the minimum voltage value is smallest, it indicates that the voltage data in this situation is closer to the square wave in the ideal situation.

At S204, a second determination step is provided, the configuration mode corresponding to the target voltage data is determined as a target configuration mode, and the linear continuous time equalizer is set to the target configuration mode.

Specifically, since the distance between the target voltage data and the boundary of the maximum voltage value or the minimum voltage value is smallest, it indicates that the voltage data in this situation is closer to the square wave in the ideal situation, and the configuration mode corresponding to the target voltage data is the most ideal configuration mode under the current condition, and the recovery effect on the loss signal is the best. The embodiments of the present disclosure provide a processor, configured to run a program. The program, when running, performs a method for controlling a signal repeater.

Specifically, a method for controlling a signal repeater includes the following operations:
At S201, a first acquisition step is provided, an output voltage signal of the comparator and statistical characteristics of the output voltage signal are acquired when the linear continuous time equalizer is in each of a plurality of different configuration modes, so as to obtain a plurality of sets of voltage data, where one set the voltage data corresponds to one configuration mode, the linear continuous time equalizer has different parameters for recovering the loss signal in any two different configuration modes, and the voltage data includes a plurality of voltage values of the output voltage signal within a predetermined time period and the number of each of the voltage values;
Specifically, the number and type of comparators connected to the linear continuous time equalizer are not limited, and the comparator may be one or more. The comparator may be a window comparator, a threshold comparator or a high-speed comparator. The window comparator is configured to compare an input signal according to set upper and lower limit thresholds, and output a high logic level when the input signal is within the range, otherwise output a low logic level. The threshold comparator is the most common type of comparator, which compares the input signal with a preset threshold, and outputs the high logic level or the low logic level when the input signal exceeds or falls below the threshold. The high-speed comparator has a fast response speed and may be configured to high-speed signal processing and data conversion applications. The different configuration modes of the linear continuous time equalizer differ in that the compensation degree for a channel attenuation signal is different, for example, different compensation degrees such as over-compensation, under-compensation, and appropriate compensation, and different degrees of parameter settings are different, so that different corresponding configuration modes are obtained. The statistical characteristics of the output voltage signal may be a statistical distribution or statistical characteristic value of the output voltage signal. The voltage data may be represented in the form of a statistical graph or a statistical table.

At S202, a second acquisition step is provided, at least one voltage values corresponding to the maximum value of the number in each set of the voltage data is acquired, so as to obtain a plurality of target voltage values, where the maximum value of the number in one set the voltage data corresponds to at least one of the voltage values;

Specifically, since in ideal situations, the signal waveform after the loss signal is perfectly recovered is a square waveform, that is, using the probability statistics theory, the probability mass is distributed at both ends of the voltage signal, that is, the number of the maximum voltage value and the minimum voltage value is the largest. However, in actual situations, the above square waveform may not be achieved, and the maximum value of the number must be a certain distance from the boundary. Therefore, the voltage value corresponding to the maximum value of the number in one set the voltage data may be one or more.

At S203, a first determination step is provided, the voltage data corresponding to the minimum value in the plurality of the target voltage values is determined as target voltage data, where the minimum value in the target voltage values corresponds to at least one set of the voltage data;

Specifically, the voltage value corresponding to the maximum value of the number in one set the voltage data may be one or more, and the target voltage values in the plurality of sets of the voltage data are compared to obtain the voltage data corresponding to the minimum value. Since the distance between the target voltage data and the boundary of the maximum voltage value or the minimum voltage value is smallest, it indicates that the voltage data in this situation is closer to the square wave in the ideal situation.

At S204, a second determination step is provided, the configuration mode corresponding to the target voltage data is determined as a target configuration mode, and the linear continuous time equalizer is set to the target configuration mode.

Specifically, since the distance between the target voltage data and the boundary of the maximum voltage value or the minimum voltage value is smallest, it indicates that the voltage data in this situation is closer to the square wave in the ideal situation, and the configuration mode corresponding to the target voltage data is the most ideal configuration mode under the current condition, and the recovery effect on the loss signal is the best. The embodiments of the present disclosure provide a device. The device includes a processor, a memory, and a program stored in the memory and runnable on the at least one processor. The processor implements at least the following steps when executing the program:
At S201, a first acquisition step is provided, an output voltage signal of the comparator and statistical characteristics of the output voltage signal are acquired when the linear continuous time equalizer is in each of a plurality of different configuration modes, so as to obtain a plurality of sets of voltage data, where one set the voltage data corresponds to one configuration mode, the linear continuous time equalizer has different parameters for recovering the loss signal in any two different configuration modes, and the voltage data includes a plurality of voltage values of the output voltage signal within a predetermined time period and the number of each of the voltage values;
At S202, a second acquisition step is provided, at least one voltage values corresponding to the maximum value of the number in each set of the voltage data is acquired, so as to obtain a plurality of target voltage values, where the maximum value of the number in one set the voltage data corresponds to at least one of the voltage values;
At S203, a first determination step is provided, the voltage data corresponding to the minimum value in the plurality of the target voltage values is determined as target voltage data, where the minimum value in the target voltage values corresponds to at least one set of the voltage data;
At S204, a second determination step is provided, the configuration mode corresponding to the target voltage data is determined as a target configuration mode, and the linear continuous time equalizer is set to the target configuration mode.

The device herein may be a server, a Personnel Computer (PC), a PAD, a mobile phone, etc.

The present disclosure further provides a computer program product, which, when executed on a data processing device, is suitable for executing a program that is initialized with at least the following method steps:
At S201, a first acquisition step is provided, an output voltage signal of the comparator and statistical characteristics of the output voltage signal are acquired when the linear continuous time equalizer is in each of a plurality of different configuration modes, so as to obtain a plurality of sets of voltage data, where one set the voltage data corresponds to one configuration mode, the linear continuous time equalizer has different parameters for recovering the loss signal in any two different configuration modes, and the voltage data includes a plurality of voltage values of the output voltage signal within a predetermined time period and the number of each of the voltage values;
At S202, a second acquisition step is provided, at least one voltage values corresponding to the maximum value of the number in each set of the voltage data is acquired, so as to obtain a plurality of target voltage values, where the maximum value of the number in one set the voltage data corresponds to at least one of the voltage values;
At S203, a first determination step is provided, the voltage data corresponding to the minimum value in the plurality of the target voltage values is determined as target voltage data, where the minimum value in the target voltage values corresponds to at least one set of the voltage data;
At S204, a second determination step is provided, the configuration mode corresponding to the target voltage data is determined as a target configuration mode, and the linear continuous time equalizer is set to the target configuration mode.

It is apparent that those skilled in the art should appreciate that the above modules and steps of the present disclosure may be implemented by a general-purpose computing device, and they may be centralized in a single computing device or distributed on a network composed of multiple computing devices; they may be implemented by a program code which is capable of being executed by the computing device, so that they may be stored in a storage device and executed by the computing device; and in some situations, the presented or described steps may be executed in an order different from that described here; or they are made into integrated circuit modules, respectively; or multiple modules and steps of them are made into a single integrated circuit module to realize. Therefore, the present disclosure is not limited to any particular combination of hardware and software.

Those skilled in the art should understand that the embodiments of the present disclosure may be provided as methods, systems, or computer program products. Therefore, the present disclosure may take the form of an entirely hardware embodiment, an entirely software embodiment, or an embodiment combining software and hardware aspects. Furthermore, the present disclosure may take the form of a computer program product implemented on one or more computer available storage media (including, but not limited to, a disk storage, a Compact Disc-ROM (CD-ROM), an optical memory, etc.) having a computer available program code embodied thereon.

The present disclosure is described with reference to flowcharts and/or block diagrams of the method, the device (system) and the computer program product according to the embodiments of the present disclosure. It should be understood that each flow and/or block in the flowcharts and/or the block diagrams and a combination of the flows and/or the blocks in the flowcharts and/or the block diagrams may be implemented by computer program instructions. These computer program instructions may be provided for a general-purpose computer, a dedicated computer, an embedded processor or processors of other programmable data processing devices to generate a machine, so that an apparatus for achieving functions designated in one or more flows of the flowcharts and/or one or more blocks of the block diagrams is generated via instructions executed by the computers or the processors of the other programmable data processing devices.

These computer program instructions may also be stored in a computer readable memory capable of guiding the computers or the other programmable data processing devices to work in a specific mode, so that a manufactured product including an instruction apparatus is generated via the instructions stored in the computer readable memory, and the instruction apparatus achieves the functions designated in one or more flows of the flowcharts and/or one or more blocks of the block diagrams.

These computer program instructions may also be loaded to the computers or the other programmable data processing devices, so that processing implemented by the computers is generated by executing a series of operation steps on the computers or the other programmable devices, and therefore the instructions executed on the computers or the other programmable devices provide a step of achieving the functions designated in one or more flows of the flowcharts and/or one or more blocks of the block diagrams.

In a typical configuration, a computing device includes one or more processors (Central Processing Unit (CPU)), an input/output interface, a network interface, and a memory.

The memory may include a volatile memory, an RAM and/or a non-volatile memory in a computer-readable medium, such as an ROM or a flash memory (flash RAM). The memory is an example of the computer-readable medium.

The computer-readable medium includes volatile and non-volatile, removable and non-removable media implemented in any method or technology for storage of information. The information may be computer-readable instructions, data structures, program modules, or other data. Examples of the computer storage media include, but are not limited to, a Phase-Change RAM (PRAM), a Static RAM (SRAM), a Dynamic RAM (DRAM), other types of RAM, ROM, Electrically Erasable Programmable ROM (EEPROM), flash memory or other memory technologies, CD-ROM, Digital Video Disks (DVDs) or other optical storage, magnetic cassette tapes, tape disk storage or other magnetic storage devices, or any other non-transmission medium which can be used to store the information that can be accessed by the computing device. As defined herein, the computer-readable medium does not include transitory media, such as modulated data signals and carriers.

It is to be noted that, terms “include” and “contain” or any other variant thereof is intended to cover nonexclusive inclusions herein, so that a process, method, commodity or device including a series of elements not only includes those elements but also includes other elements which are not clearly listed or further includes elements intrinsic to the process, the method, the commodity or the device. Under the condition of no more limitations, an element defined by the statement “including a/an . . . ” does not exclude existence of the same other elements in a process, method, commodities or device including the element.

From the above description, it may be seen that the above embodiments of the present disclosure achieve the following technical effects:
1). According to a method for controlling a signal repeater of the present disclosure, the signal repeater includes the linear continuous time equalizer and the comparator which are in communication connection. First, the output voltage signal of the comparator and the statistical characteristics of the output voltage signal are acquired when the linear continuous time equalizer is in each of the plurality of different configuration modes, and the plurality of sets of the voltage data are obtained. Then, the voltage value corresponding to the maximum value of the number in each set of the voltage data is acquired, and the plurality of the target voltage values are obtained, where the maximum value of the number in one set the voltage data corresponds to at least one of the voltage values. Then, the voltage data corresponding to the minimum value in the plurality of the target voltage values is determined as the target voltage data, where the minimum value in the target voltage values corresponds to at least one set of the voltage data. Finally, the configuration mode corresponding to the target voltage data is determined as the target configuration mode, and the linear continuous time equalizer is set to the target configuration mode. By adding the comparator on the basis of the signal repeater in the related art, performing sampling and statistics on the signal after channel recovery through the comparator, obtaining voltage data results in different configuration modes of the equalizer, and analyzing the voltage data results, a channel state may be quickly acquired, and then the configuration mode of the equalizer is changed, so as to better and quickly adapt to the recovery of the loss signal in different channel states, thereby solving the technical problem that the channel signal of the signal repeater is not recovered and matched timely.
2). According to an apparatus for controlling the signal repeater of the present disclosure, the signal repeater includes the linear continuous time equalizer and the comparator which are in communication connection, where the linear continuous time equalizer is configured to recover the loss signal which is received. The apparatus includes: the first acquisition unit, configured to acquire the output voltage signal of the comparator and the statistical characteristics of the output voltage signal when the linear continuous time equalizer is in each of the plurality of different configuration modes, and obtain the plurality of sets of the voltage data; the second acquisition unit, configured to acquire the voltage value corresponding to the maximum value of the number in each set of the voltage data, and obtain the plurality of the target voltage values, where the maximum value of the number in one set the voltage data corresponds to at least one of the voltage values; the first determination unit, configured to determine the voltage data corresponding to the minimum value in the plurality of the target voltage values as the target voltage data, where the minimum value in the target voltage values corresponds to at least one set of the voltage data; and the second determination unit, configured to determine the configuration mode corresponding to the target voltage data as the target configuration mode, and set the linear continuous time equalizer to the target configuration mode. By adding the comparator on the basis of the signal repeater in the related art, performing sampling and statistics on the signal after channel recovery through the comparator, obtaining voltage data results in different configuration modes of the equalizer, and analyzing the voltage data results, a channel state may be quickly acquired, and then the configuration mode of the equalizer is changed, so as to better and quickly adapt to the recovery of the loss signal in different channel states, thereby solving the technical problem that the channel signal of the signal repeater is not recovered and matched timely.

The above are only the preferred embodiments of the present disclosure and are not intended to limit the present disclosure. For those skilled in the art, the present disclosure may have various modifications and variations. Any modifications, spirit and equivalent replacements, improvements and the like made within the spirit and principle of the present disclosure shall fall within the scope of protection of the present disclosure.

1. A method for controlling a signal repeater, wherein the signal repeater comprises a linear continuous time equalizer and a comparator which are in communication connection, wherein the linear continuous time equalizer is configured to recover a loss signal which is received, and the method comprises:
a first acquisition step, acquiring an output voltage signal of the comparator and statistical characteristics of the output voltage signal when the linear continuous time equalizer is in each of a plurality of different configuration modes, so as to obtain a plurality of sets of voltage data, wherein one set the voltage data corresponds to one configuration mode, the linear continuous time equalizer has different parameters for recovering the loss signal in any two different configuration modes, and the voltage data comprises a plurality of voltage values of the output voltage signal within a predetermined time period and a number of each of the voltage values;
a second acquisition step, acquiring at least one voltage values corresponding to a maximum value of the number in each set of the voltage data, so as to obtain a plurality of target voltage values, wherein the maximum value of the number in one set the voltage data corresponds to at least one of the voltage values;
a first determination step, determining a voltage data corresponding to a minimum value in the plurality of the target voltage values as target voltage data, wherein the minimum value in the target voltage values corresponds to at least one set of the voltage data; and
a second determination step, determining the configuration mode corresponding to the target voltage data as a target configuration mode, and setting the linear continuous time equalizer to the target configuration mode.

2. The method according to claim 1, wherein, in a case that the maximum value of the number of one set the voltage data corresponds to one voltage value, the second acquisition step comprises:
determining one voltage value corresponding to the maximum value of the number of the voltage data as the target voltage value.

3. The method according to claim 1, wherein, in a case that the maximum value of the number of one set the voltage data corresponds to a plurality of the voltage values, the second acquisition step comprises:
determining the minimum value in the plurality of the voltage values corresponding to the maximum value of the number of the voltage data as the target voltage value.

4. The method according to claim 1, wherein, in a case that the minimum value in the target voltage values corresponds to one set of the voltage data, the first determination step comprises:
determining one set the voltage data corresponding to the minimum value in the plurality of the target voltage values as the target voltage data.

5. The method according to claim 1, wherein, in a case that the minimum value in the target voltage values corresponds to a plurality of sets of the voltage data, the first determination step comprises:
determining whether a number of sets of the voltage data corresponding to the minimum value in the plurality of the target voltage values is an odd number;
in a case that the number of sets of the voltage data corresponding to the minimum value in the plurality of the target voltage values is the odd number, sorting the plurality of sets of the voltage data according to intensity of the configuration mode corresponding to each set of the voltage data, so as to obtain sequence data, and determining the voltage data corresponding to a median in the sequence data as the target voltage data, wherein the intensity of the configuration mode is intensity of the linear continuous time equalizer to recover the loss signal; and
in a case that the number of sets of the voltage data corresponding to the minimum value in the plurality of the target voltage values is not the odd number, acquiring voltage differences corresponding to the plurality of sets of the voltage data, so as to obtain the plurality of the voltage differences, and determining the voltage data corresponding to the maximum value in the plurality of the voltage differences as the target voltage data, wherein the voltage difference is a difference between a first voltage value and a second voltage value in one set of voltage data, the first voltage value is a voltage value corresponding to the maximum value of the number, and the second voltage value is a voltage value corresponding to the maximum value of the number remaining except the maximum number.

6. The method according to claim 1, wherein the signal repeater further comprises a reference signal generator, wherein the reference signal generator is configured to generate a reference signal and input same into the comparator, and before the first acquisition step, the method further comprises:
a preprocessing step, improving resolution of the reference signal.

7. The method according to claim 6, wherein, in a case that the minimum value in the target voltage value corresponds to the plurality of the voltage data, the first determination step comprises:
acquiring voltage differences corresponding to the plurality of sets of the voltage data, so as to obtain the plurality of the voltage differences, and determining the voltage data corresponding to the maximum value in the plurality of the voltage differences as the target voltage data, wherein the voltage difference is a difference between a first voltage value and a second voltage value in one set voltage data, the first voltage value is a voltage value corresponding to the maximum value of the number, and the second voltage value is a voltage value corresponding to the maximum value of a number remaining except the maximum number.

8. (canceled)

9. A non-transitory computer readable storage medium, comprising a stored program, wherein the program, when running, controls a device where the computer-readable storage medium is located to perform a method for controlling a signal repeater, wherein the signal repeater comprises a linear continuous time equalizer and a comparator which are in communication connection, wherein the linear continuous time equalizer is configured to recover a loss signal which is received, and the method for controlling the signal repeater comprises:
a first acquisition step, acquiring an output voltage signal of the comparator and statistical characteristics of the output voltage signal when the linear continuous time equalizer is in each of a plurality of different configuration modes, so as to obtain a plurality of sets of voltage data, wherein one set the voltage data corresponds to one configuration mode, the linear continuous time equalizer has different parameters for recovering the loss signal in any two different configuration modes, and the voltage data comprises a plurality of voltage values of the output voltage signal within a predetermined time period and a number of each of the voltage values;
a second acquisition step, acquiring at least one voltage values corresponding to a maximum value of the number in each set of the voltage data, so as to obtain a plurality of target voltage values, wherein the maximum value of the number in one set the voltage data corresponds to at least one of the voltage values;
a first determination step, determining a voltage data corresponding to a minimum value in the plurality of the target voltage values as target voltage data, wherein the minimum value in the target voltage values corresponds to at least one set of the voltage data; and
a second determination step, determining the configuration mode corresponding to the target voltage data as a target configuration mode, and setting the linear continuous time equalizer to the target configuration mode.

10. An electronic apparatus, comprising a memory and a processor, wherein the memory stores a computer program, and the processor is configured to perform a method for controlling a signal repeater through the computer program, wherein the signal repeater comprises a linear continuous time equalizer and a comparator which are in communication connection, wherein the linear continuous time equalizer is configured to recover a loss signal which is received, and the method for controlling the signal repeater comprises:
a first acquisition step, acquiring an output voltage signal of the comparator and statistical characteristics of the output voltage signal when the linear continuous time equalizer is in each of a plurality of different configuration modes, so as to obtain a plurality of sets of voltage data, wherein one set the voltage data corresponds to one configuration mode, the linear continuous time equalizer has different parameters for recovering the loss signal in any two different configuration modes, and the voltage data comprises a plurality of voltage values of the output voltage signal within a predetermined time period and a number of each of the voltage values;
a second acquisition step, acquiring at least one voltage values corresponding to a maximum value of the number in each set of the voltage data, so as to obtain a plurality of target voltage values, wherein the maximum value of the number in one set the voltage data corresponds to at least one of the voltage values;
a first determination step, determining a voltage data corresponding to a minimum value in the plurality of the target voltage values as target voltage data, wherein the minimum value in the target voltage values corresponds to at least one set of the voltage data; and
a second determination step, determining the configuration mode corresponding to the target voltage data as a target configuration mode, and setting the linear continuous time equalizer to the target configuration mode.

11. The non-transitory computer readable storage medium according to claim 9, wherein, in a case that the maximum value of the number of one set the voltage data corresponds to one voltage value, the second acquisition step comprises:
determining one voltage value corresponding to the maximum value of the number of the voltage data as the target voltage value.

12. The non-transitory computer readable storage medium according to claim 9, wherein, in a case that the maximum value of the number of one set the voltage data corresponds to a plurality of the voltage values, the second acquisition step comprises:
determining the minimum value in the plurality of the voltage values corresponding to the maximum value of the number of the voltage data as the target voltage value.

13. The non-transitory computer readable storage medium according to claim 9, wherein, in a case that the minimum value in the target voltage values corresponds to one set of the voltage data, the first determination step comprises:
determining one set the voltage data corresponding to the minimum value in the plurality of the target voltage values as the target voltage data.

14. The non-transitory computer readable storage medium according to claim 9, wherein, in a case that the minimum value in the target voltage values corresponds to a plurality of sets of the voltage data, the first determination step comprises:
determining whether a number of sets of the voltage data corresponding to the minimum value in the plurality of the target voltage values is an odd number;
in a case that the number of sets of the voltage data corresponding to the minimum value in the plurality of the target voltage values is the odd number, sorting the plurality of sets of the voltage data according to intensity of the configuration mode corresponding to each set of the voltage data, so as to obtain sequence data, and determining the voltage data corresponding to a median in the sequence data as the target voltage data, wherein the intensity of the configuration mode is intensity of the linear continuous time equalizer to recover the loss signal; and
in a case that the number of sets of the voltage data corresponding to the minimum value in the plurality of the target voltage values is not the odd number, acquiring voltage differences corresponding to the plurality of sets of the voltage data, so as to obtain the plurality of the voltage differences, and determining the voltage data corresponding to the maximum value in the plurality of the voltage differences as the target voltage data, wherein the voltage difference is a difference between a first voltage value and a second voltage value in one set of voltage data, the first voltage value is a voltage value corresponding to the maximum value of the number, and the second voltage value is a voltage value corresponding to the maximum value of the number remaining except the maximum number.

15. The non-transitory computer readable storage medium according to claim 9, wherein the signal repeater further comprises a reference signal generator, wherein the reference signal generator is configured to generate a reference signal and input same into the comparator, and before the first acquisition step, the method further comprises:
a preprocessing step, improving resolution of the reference signal.

16. The non-transitory computer readable storage medium according to claim 10, wherein, in a case that the minimum value in the target voltage value corresponds to the plurality of the voltage data, the first determination step comprises:
acquiring voltage differences corresponding to the plurality of sets of the voltage data, so as to obtain the plurality of the voltage differences, and determining the voltage data corresponding to the maximum value in the plurality of the voltage differences as the target voltage data, wherein the voltage difference is a difference between a first voltage value and a second voltage value in one set voltage data, the first voltage value is a voltage value corresponding to the maximum value of the number, and the second voltage value is a voltage value corresponding to the maximum value of a number remaining except the maximum number.

17. The electronic apparatus according to claim 16, wherein, in a case that the maximum value of the number of one set the voltage data corresponds to one voltage value, the second acquisition step comprises:
determining one voltage value corresponding to the maximum value of the number of the voltage data as the target voltage value.

18. The electronic apparatus according to claim 16, wherein, in a case that the maximum value of the number of one set the voltage data corresponds to a plurality of the voltage values, the second acquisition step comprises:
determining the minimum value in the plurality of the voltage values corresponding to the maximum value of the number of the voltage data as the target voltage value.

19. The electronic apparatus according to claim 16, wherein, in a case that the minimum value in the target voltage values corresponds to one set of the voltage data, the first determination step comprises:
determining one set the voltage data corresponding to the minimum value in the plurality of the target voltage values as the target voltage data.

20. The electronic apparatus according to claim 16, wherein, in a case that the minimum value in the target voltage values corresponds to a plurality of sets of the voltage data, the first determination step comprises:
determining whether a number of sets of the voltage data corresponding to the minimum value in the plurality of the target voltage values is an odd number;
in a case that the number of sets of the voltage data corresponding to the minimum value in the plurality of the target voltage values is the odd number, sorting the plurality of sets of the voltage data according to intensity of the configuration mode corresponding to each set of the voltage data, so as to obtain sequence data, and determining the voltage data corresponding to a median in the sequence data as the target voltage data, wherein the intensity of the configuration mode is intensity of the linear continuous time equalizer to recover the loss signal; and
in a case that the number of sets of the voltage data corresponding to the minimum value in the plurality of the target voltage values is not the odd number, acquiring voltage differences corresponding to the plurality of sets of the voltage data, so as to obtain the plurality of the voltage differences, and determining the voltage data corresponding to the maximum value in the plurality of the voltage differences as the target voltage data, wherein the voltage difference is a difference between a first voltage value and a second voltage value in one set of voltage data, the first voltage value is a voltage value corresponding to the maximum value of the number, and the second voltage value is a voltage value corresponding to the maximum value of the number remaining except the maximum number.

21. The electronic apparatus according to claim 16, wherein the signal repeater further comprises a reference signal generator, wherein the reference signal generator is configured to generate a reference signal and input same into the comparator, and before the first acquisition step, the method further comprises:
a preprocessing step, improving resolution of the reference signal.
